(19) United States
(12) Patent Application Publication
(10) Pub. No.: US 2010/0103675 A1
(43) Pub. Date: Apr. 29, 2010

(54) LED LAMP HAVING A LOCKING DEVICE

(76) Inventors: Hung-Wen Yu, Chung-Ho City (TW); Hsin-Ming Li, Chung-Ho City (TW)

Correspondence Address: HDLS Patent & Trademark Services, P.O. BOX 220746, CHANTILLY, VA, 20153-0746, US

(21) Appl. No.: 12/258,617

(22) Filed: Oct. 27, 2008

(51) Int. Cl. F21V 29/00

(52) U.S. Cl. 362/253

(57) ABSTRACT

A LED lamp having a locking device includes a lamp housing, a heat-sink, a locking device and a LED light-emitting module. The lamp housing has a cylinder. The heat-sink is formed with an annular wall. The locking device comprises a first thread formed at an outer periphery of the cylinder, a hook extending from one end of the cylinder, a second thread formed in the inner wall of the annular wall and threadedly connected with the first thread, and a groove defined on the annular wall and locked with the hook. The LED light-emitting module is placed in the heat-sink and connected to an end of the heat-sink away from the lamp housing. By the above arrangement, a secure and firm connection between the lamp housing and the heat-sink can be achieved.

### BACKGROUND OF THE INVENTION

1. Field of the Invention

The present invention relates to a LED lamp, and in particular to a LED lamp having a locking device.

2. Description of Prior Art

Since light-emitting diodes have many advantageous features such as high intensity, low power consumption and long life, the light-emitting diodes have been widely used in various lighting lamps or light-emitting devices so as to replace traditional bulbs. In order to increase the illuminating range and intensity of these lighting lamps or light-emitting device, a plurality of LEDs is assembled together to form a LED module. Then, the LED module is combined with a dissipating heat-sink and a lamp housing respectively. However, since the heat-sink and the lamp housing are made of different materials respectively, it is very difficult to fix them to each other. Furthermore, each country establishes individual strict regulation for safety. Therefore, it is an important issue for the present inventor to improve the conventional LED lamp.

The conventional LED lamp includes a lamp housing, a heat-sink and a LED light-emitting module. The lamp housing has a cylinder. The outer periphery of the cylinder is formed into an outer thread. The heat-sink is formed with an annular wall. The inner face of the annular wall is formed with an inner thread for threadedly connecting to the outer thread. The LED light-emitting module is placed in the heat-sink and connected to one end of the heat-sink, which is away from the lamp housing. By this arrangement, a LED lamp can be constituted.

However, in practice, the conventional LED lamp still has some problems as follows. Since the lamp housing and the heat-sink are made of a plastic material and a metallic material respectively, the dimension and tolerance of each element cannot be well controlled. On the other hand, the connection between the inner thread and the outer thread is only achieved by means of threads, which is not secure enough. As a result, the two elements may be loosened or separated due to the vibrations generated in transportation or delivery or installation.

### SUMMARY OF THE INVENTION

The present invention is to provide a LED lamp having a locking device, whereby a secure and firm connection between the lamp housing and the heat-sink can be achieved.

Accordingly, the present invention provides a LED lamp having a locking device. The LED lamp includes a lamp housing, a heat-sink, a locking device and a LED light-emitting module. The lamp housing has a cylinder. The heat-sink is formed with an annular wall. The locking device comprises a first thread formed at an outer periphery of the cylinder, a hook extending from one end of the cylinder, a second thread formed in the inner wall of the annular wall of the heat-sink and threadedly connected with the first thread, and a locking groove provided on the annular wall of the heat-sink and locked with the hook. The LED light-emitting module is placed and connected in an end of the heat-sink opposite from the lamp housing.

The present invention is to provide a LED lamp having a locking device, in which an elastic gasket is sandwiched between the lamp housing and the heat-sink, thereby preventing the loosening caused by the vibrations generated in transportation and overcoming the problems of assembling tolerance occurred in manufacturing each constituent element.

The present invention is to provide a LED lamp having a locking device, in which the cover and the heat-sink are provided with a buckling bar and a groove respectively that are connected with each other, thereby achieving a three-dimensional locking effect so as to increase the degree of fixation.

### BRIEF DESCRIPTION OF DRAWING

FIG. 1 is an exploded perspective view showing the LED lamp of the present invention;

FIG. 2 is a perspective view showing the external appearance of the LED lamp of the present invention;

FIG. 3 is a cross-sectional view of FIG. 2;

FIG. 4 is a partially enlarged view showing the portion A in FIG. 3; and

FIG. 5 is a partially enlarged view showing the portion B in FIG. 3.

### DETAILED DESCRIPTION OF THE INVENTION

The detailed description and technical contents of the present invention will be explained with reference to the accompanying drawings. However, the drawings are illustrative purpose only and should not limit the scope of present intention.

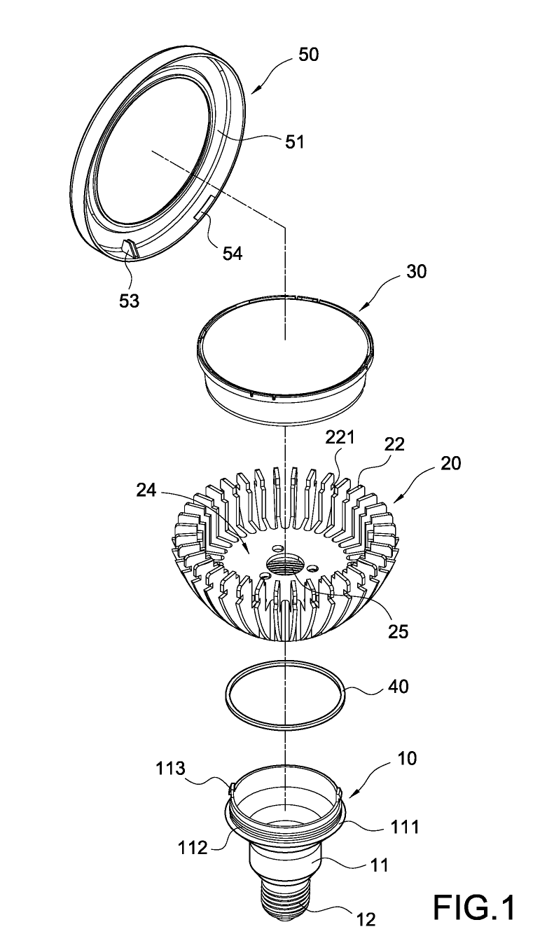

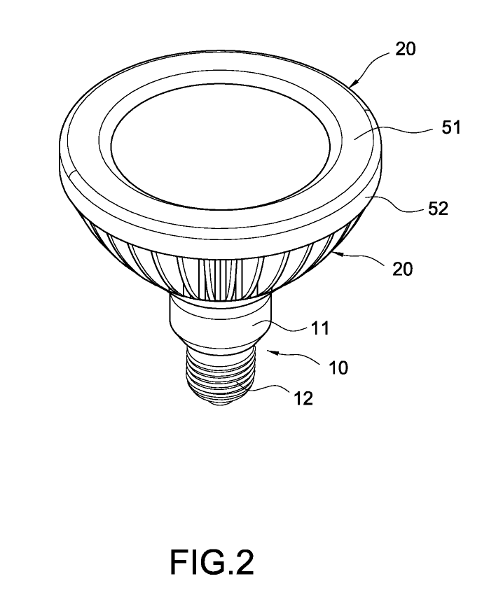

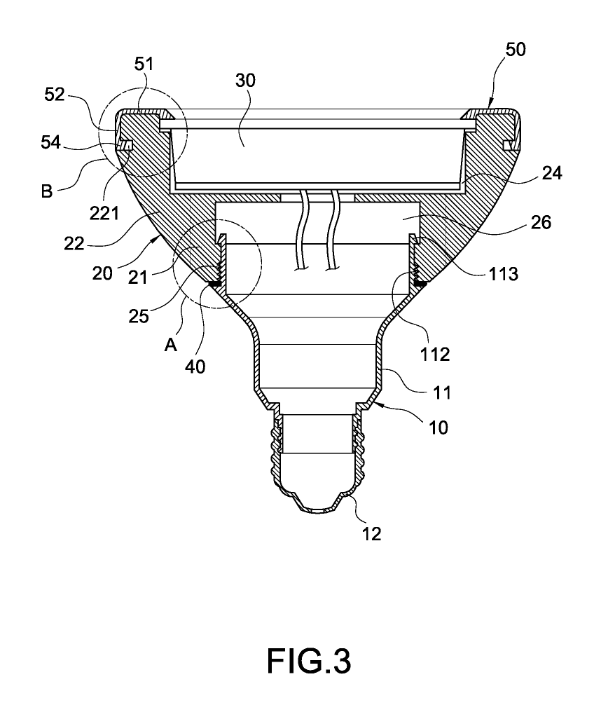

Please refer to FIGS. 1 to 3. FIG. 1 is an exploded perspective view showing the LED lamp of the present invention. FIG. 2 is an assembled view showing the external appearance of the LED lamp of the present invention. FIG. 3 is an assembled cross-sectional view of FIG. 2. The present invention provides a LED lamp having a locking device, which includes a lamp housing 10, a heat-sink 20 and a LED light-emitting module 30.

The lamp housing 10 is constituted by a stepped cylinder 11 and a copper head 12. The cylinder 11 is an insulator made of insulating materials such as plastic material. An end of the cylinder 11 away from the copper head 12 is formed with an annular flange 111.

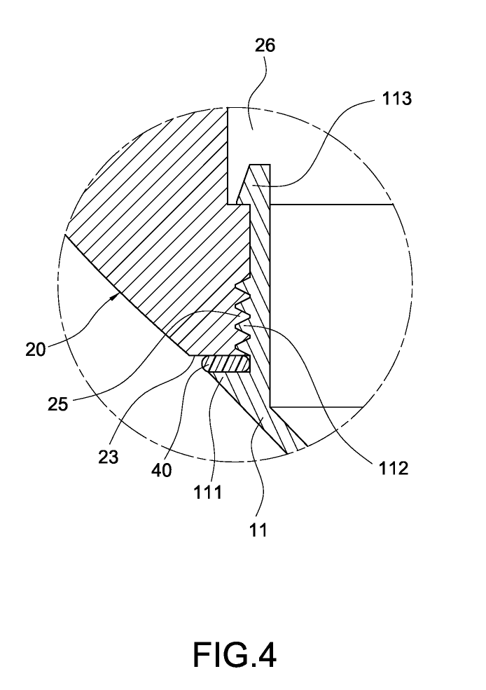

The heat-sink 20 is made of materials having good thermal conductivity such as aluminum. The heat-sink 20 has a circular annular wall 21 (FIG. 3). The outer peripheral surface of the annular wall 21 protrudes outwards to form a plurality of heat-sink fins 22. A groove 221 is presented on each heat-sink fins 22. The connecting end between the annular wall 21 and the cylinder 11 is formed with a plane 23 (FIG. 4) for abutting the flange 111. Further, the central portions of the respective heat-sink fin 22 surround to each other to define an accommodating space 24.

The locking device comprises a first thread 112 formed on the outer periphery of the cylinder 11 and located above the flange 111, a hook 113 extending from an end of the cylinder 11 away from the first thread 112, a second thread 25 formed on the inner wall of the annular wall 21 and threadedly connected to the first thread 112, and a groove 26 provided on one end of the annular wall 21 away from the second thread 25 and locked to the hook 113. In the present embodiment, the first thread 112 is an outer thread, and the second thread 25 is an inner thread. The hook 113 can be formed into a single piece.

The LED light-emitting module 30 is mainly constituted of a circuit board, LED, lenses and a light-reflecting cover. The circuit board is provided with leads for electrically connecting to the lamp housing 10. Since the circuit board is of a conventional construction, it is not described herein for simplicity. The LED light-emitting module 30 is placed in the accommodating space 24 of the heat-sink 20 and is connected to an end of the heat-sink 20 away from the lamp housing 10.

With reference to FIGS. 3 and 4, preferably, the present invention further includes an elastic gasket 40. The elastic gasket 40 is made of elastically-deformable materials such as rubber, and is sandwiched between the flange 111 and the plane 23, thereby generating an elastic clamping force between the lamp housing 10 and the heat-sink 20.

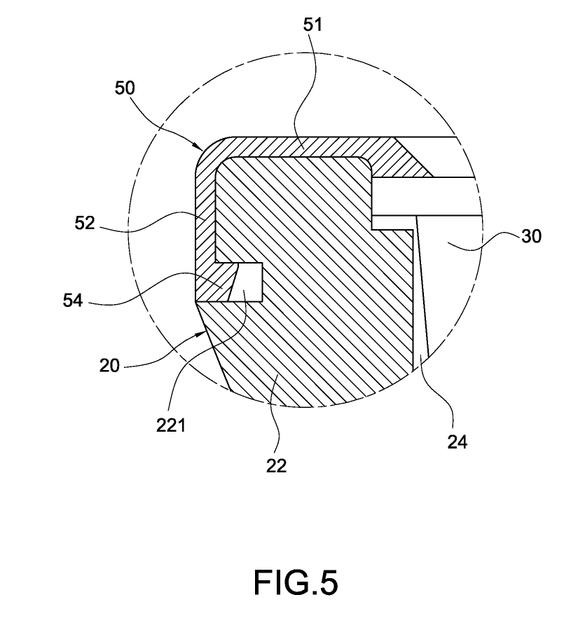

With reference to FIGS. 1, 3 and 5, preferably, the present invention further includes a cover 50 which is constituted of an annular plate 51 and an encircling plate 52 bent from the periphery of the annular plate 51. The interior of the annular plate 51 and the encircling plate 52 is formed with a clamping plate 53 (FIG. 1) for positioning the heat-sink fins 22. In the present embodiment, the clamping plate 53 is constituted by two parallel sheets, thereby preventing the heat-sink 20 and the cover 50 from rotating in a radial direction. Further, the inner wall on the bottom edge of the encircling plate 52 extends to form a buckling bar 54 (FIG. 1) for buckling to the groove 221 of the heat-sink fin 22 in a three-dimensional direction. In this way, the LED light-emitting module can be firmly connected to the heat-sink 20.

According to the above description, the LED lamp having a locking device according to the present invention demonstrates industrial applicability, novelty and inventive steps. Further, the structure of the present invention has not been seen in articles of the same kind or let in public use. Therefore, the present invention conforms to the requirements for a utility model patent.

What is claimed is:

1. A LED lamp having a locking device, comprising:
a lamp housing having a cylinder;
a heat-sink formed with an annular wall;
a locking device having a first thread formed at an outer periphery of the cylinder, a hook extending from one end of the cylinder, a second thread formed in an inner wall of the annular wall and threadedly connected with the first thread, and a groove provided on the annular wall and locked with the hook; and
a LED light-emitting module placed in the heat-sink and connected to an end of the heat-sink away from the lamp housing.

2. The LED lamp having a locking device according to claim 1, wherein the lamp housing further comprises a copper head connected to the cylinder.

3. The LED lamp having a locking device according to claim 1, wherein the cylinder is an insulator.

4. The LED lamp having a locking device according to claim 1, wherein the first thread is an outer thread, and the second thread is an inner thread matching with the outer thread.

5. The LED lamp having a locking device according to claim 1, wherein an outer peripheral surface of the annular wall protrudes to form a plurality of heat-sink fins, central portions of the heat-sink fins surrounding to each other to define an accommodating space, and the LED light-emitting module is received in the accommodating space.

6. The LED lamp having a locking device according to claim 1, further comprising an elastic gasket, sandwiched between the flange formed on cylinder and the annular plane formed between the annular wall of heat-sink and the cylinder.

7. The LED lamp having a locking device according to claim 6, wherein the elastic gasket is made of rubber.

8. The LED lamp having a locking device according to claim 1, further comprising a cover connected at one end of the heat-sink away from the lamp housing.

9. The LED lamp having a locking device according to claim 8, wherein the cover comprises an annular plate and an encircling plate bent from the periphery of the annular plate, the interior of the annular plate and the encircling plate forms a clamping plate, the outer peripheral surface of the annular wall protrudes to form a heat-sink fin that is inserted in the clamping plate.

10. The LED lamp having a locking device according to claim 9, wherein a groove is defined on the heat-sink fin, and the inner wall of the encircling plate extends to form a buckling bars for buckling to the groove.
